(19) United States
(12) Patent Application Publication
(10) Pub. No.: US 2014/0027361 A1
(43) Pub. Date: Jan. 30, 2014

(54) FILTRATION SYSTEM

(71) Applicant: Michael PENNINGTON, Mission Viejo, CA (US)

(72) Inventor: Michael PENNINGTON, Mission Viejo, CA (US)

(73) Assignee: LANCER CORPORATION, San Antonio, TX (US)

(21) Appl. No.: 13/916,896

(22) Filed: Jun. 13, 2013

Related U.S. Application Data
(60) Provisional application No. 61/741,610, filed on Jul. 24, 2012.

(51) Int. Cl. B01D 35/147

(52) U.S. Cl. CPC B01D 35/1475
USPC 210/120; 29/428; 29/426.1

(57) ABSTRACT

A filtration system includes a filter assembly removably coupled with a manifold. The coupling of the filter assembly coupled with the manifold aligns an intake port of the filter assembly with an inlet tube of the manifold and communicates a flow tube of the filter assembly with an exit tube of the manifold. The filter assembly pushes a shut-off valve of the manifold from its normally closed position to its open position. Liquid then flows into the filter assembly from the inlet tube of the manifold and filtered liquid flows into exit tube of the manifold from the flow tube of the filter assembly. The filter assembly further pushes a pressure relief valve of the manifold from its normally open position to its closed position.

### BACKGROUND OF THE INVENTION

1. Field of the Invention

The field of the invention relates generally to water filtration systems more particularly, to water filtration systems incorporating a replaceable filter housing.

2. Description of the Related Art

It has become commonplace to provide purified drinking water in residential as well as commercial establishments. This has been accomplished with filtration systems that flow water through filter media. Such systems commonly include a manifold engaged with a filter housing containing a filter media. The manifold connects at an inlet with a water source and at an outlet with an end use device such as a faucet. The filter housing typically connects with the manifold such that manifold inlet delivers water into the filter housing for contact with the filter media. Likewise, the filter housing connects with the manifold outlet such that filtered water exiting the filter housing flows through the manifold outlet and to the end use device. Although current filtration systems operate adequately, a filtration system that incorporates a locking mechanism designed to withstand greater pressures while also including an automatic shut-off valve and automatic pressure relief valve would provide an improvement in the field of water filtration.

### SUMMARY OF THE INVENTION

In accordance with the present invention, a filtration system includes a filter assembly removably coupled with a manifold. The manifold defines a mating tube cavity and a support shoulder cavity adjacent the mating tube cavity. An inlet tube communicates with an inlet port and the mating tube cavity, and an exit tube communicates with the mating tube cavity and an outlet port. A shut-off valve cavity intersects the inlet tube, and a pressure relief valve passage communicates with the mating cavity and exterior to the manifold. A shut-off valve is disposed in the shut-off valve cavity. The shut-off valve resides in a normally closed position that blocks the inlet tube and is movable to an open position. A pressure relief valve disposed in the pressure relief valve passage communicates with the mating tube cavity. The pressure relief valve resides in a normally open position and is movable to a closed position.

The filter assembly includes a filter cartridge, a filter housing having the filter cartridge disposed therein, an interlocking connector disposed atop and in fluid communication with the filter cartridge and coupled with the filter housing, and a flow tube disposed within the filter cartridge and the interlocking connector and communicating exterior to the interlocking connector. The interlocking connector includes an intake port and a support shoulder. The interlocking connector either permanently connects with the filter housing or removably connects with the filter housing. Engagement of the interlocking connector with the manifold inserts the mating tube within the mating tube cavity and aligns the intake port of the interlocking connector with the inlet tube of the manifold. Engagement of the interlocking connector with the manifold further moves the shut-off valve from its normally closed position to its open position and the pressure relief valve from its normally open position to its closed position, thereby facilitating the delivery of liquid into the filter cartridge. Still further, engagement of the interlocking connector with the manifold aligns the flow tube with the mating cavity such that filtered liquid from the filter cartridge flows from the flow tube into the mating cavity and to the exit port through the exit tube.

The shut-off valve includes a piston, cap, plunger, and biasing member. The piston includes an aperture therethrough and is disposed in the shut-off valve cavity. The cap is disposed in the shut-off valve cavity for securing the piston within the shut-off valve cavity. The plunger connects with the piston and extends from the shut-off valve cavity. The biasing member is disposed in the shut-off valve cavity and coupled with the piston. The biasing member biases the piston to block the inlet tube. The interlocking connector upon engagement with the manifold pushes the plunger, thereby moving the piston within the shut-off valve cavity such that its aperture aligns with the inlet tube of the manifold. In particular, the support shoulder of the interlocking connector pushes the plunger of the shut-off valve, thereby moving the piston within the shut-off valve cavity such that its aperture aligns with the inlet tube of the manifold.

The pressure relief valve includes a piston, cap, plunger, and biasing member. The piston and the cap are disposed in the pressure relief valve passage. The cap includes an aperture therethrough communicating exterior to the manifold. The plunger connects with the piston and extends from the pressure relief valve passage into the mating cavity. The biasing member is disposed in the pressure relief valve passage and coupled with the piston. The biasing member biases the piston away from the aperture of the cap. Engagement of the interlocking connector with the manifold pushes the plunger, thereby moving the piston within the pressure relief valve passage such that the piston seals the aperture of the cap. In particular, the mating tube of the interlocking connector pushes the plunger of the pressure relief valve during engagement. Removal of the interlocking connector from the manifold results in the biasing member biasing the piston away from the aperture of the cap such that liquid escapes through the aperture of the cap, thereby relieving pressure and preventing leakage.

The manifold includes at least one locking slot, and the interlocking connector includes at least one locking tab. Engagement of the interlocking connector with the manifold inserts the at least one locking tab into the at least one locking slot. Moreover, rotation of the interlocking connector relative to the manifold locks the at least one locking tab into the at least one locking slot.

A method for a filtration system includes coupling and decoupling a filter assembly with a manifold. Coupling the filter assembly with the manifold includes inserting at least one locking tab of the filter assembly into at least one locking slot of the manifold and rotating the filter assembly relative to the manifold thereby locking the at least one locking tab into the at least one locking slot. Coupling the filter assembly with the manifold aligns an intake port of the filter assembly with an inlet tube of the manifold and communicates a flow tube of the filter assembly with an exit tube of the manifold. The filter assembly when coupled with the manifold pushes a shut-off valve of the manifold from its normally closed position to its open position such that liquid flows into the filter assembly from the inlet tube of the manifold and filtered liquid flows into exit tube of the manifold from the flow tube of the filter assembly. The filter assembly when coupled with the manifold also pushes a pressure relief valve of the manifold from its normally open position to its closed position.

Decoupling the filter assembly from the manifold releases contact of the shut-off valve with the filter assembly such that the shut-off valve returns from its open position to its normally closed position, thereby preventing liquid flow into the filter assembly from the inlet tube of the manifold. Decoupling the filter assembly from the manifold also releases contact of the pressure relief valve with the filter assembly such that the pressure relief valve returns from its closed position to its normally open position, thereby allowing an escape of liquid through the pressure relief valve that relieves pressure and prevents leakage. A new filter assembly may be coupled with the manifold after the decoupling of the prior filter assembly.

### BRIEF DESCRIPTION OF DRAWINGS

FIG. 1 is a cross-section of the filter assembly.

FIG. 2 is a perspective view of the filter assembly and the manifold.

FIG. 3 is perspective view of the manifold.

FIG. 4 is cross-sectional view illustrating the manifold uncoupled from the filter assembly.

FIG. 5 is a cross-sectional view illustrating the manifold coupled to the filter assembly

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Figures are not necessarily to scale, and some features may be exaggerated to show details of particular components or steps.

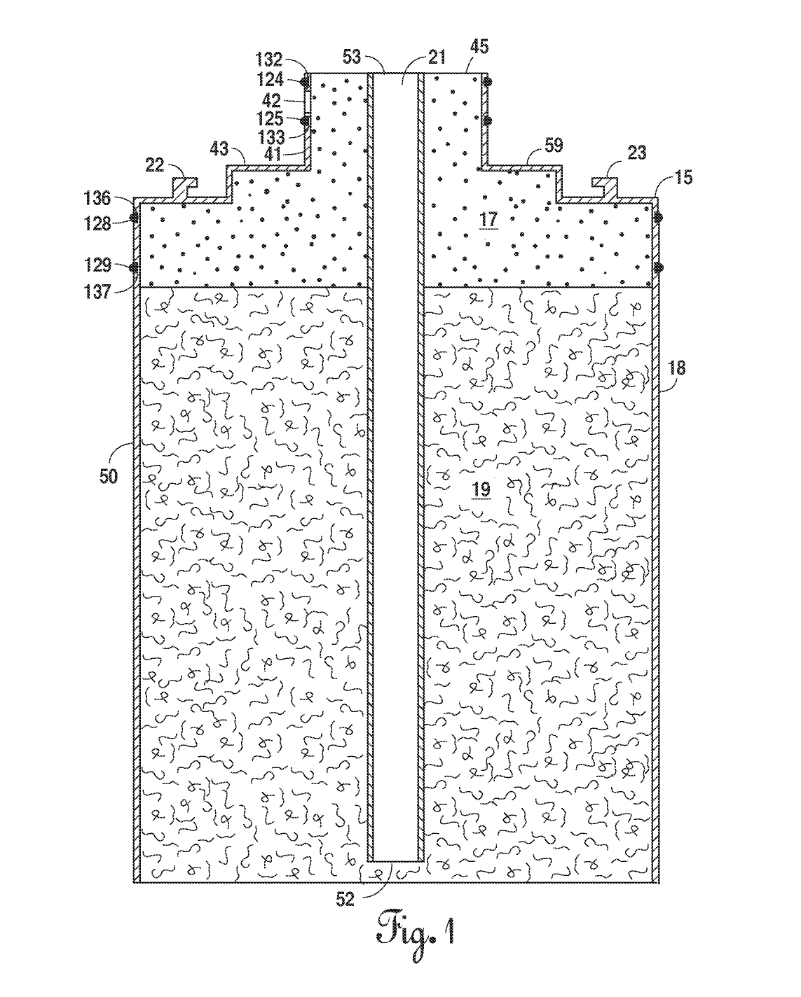

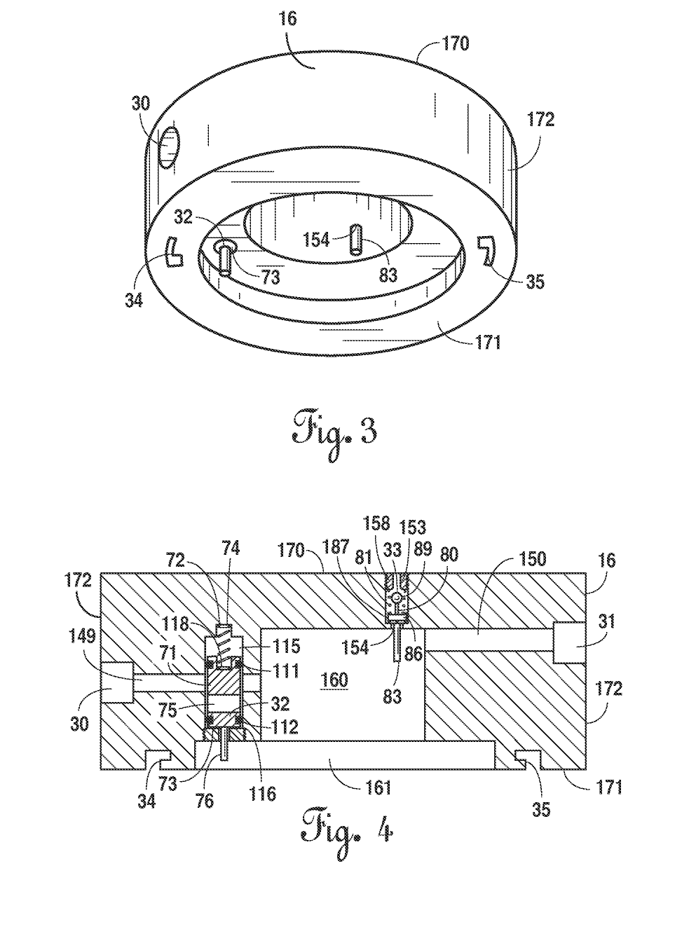

FIGS. 1-5 illustrate a filtration system 10. The filtration system 10 includes a manifold 16 and a filter assembly 15.

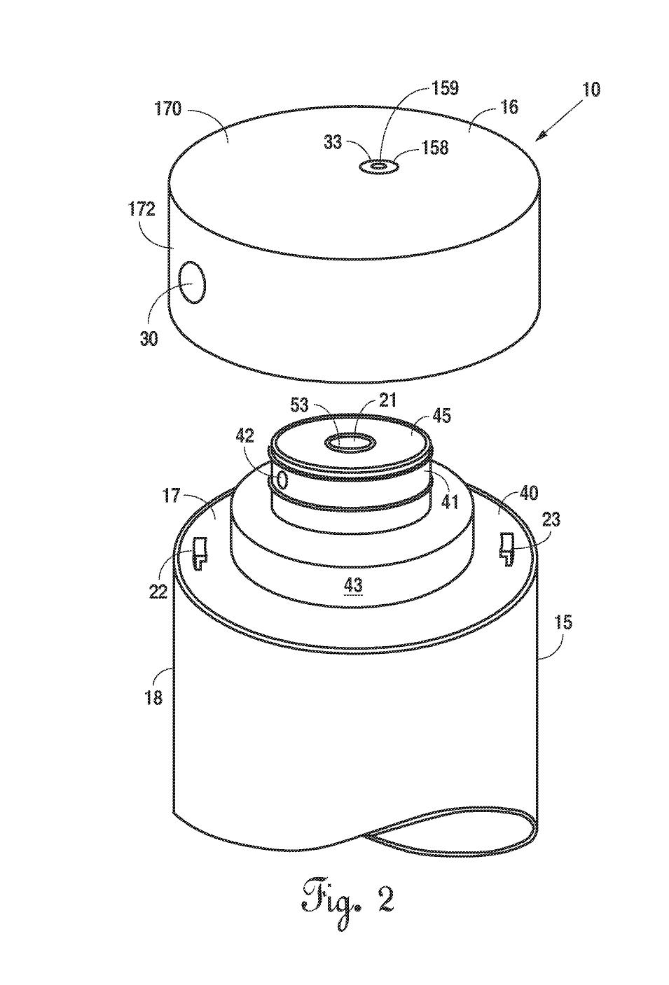

FIGS. 2-5 illustrate the manifold 16. The manifold 16 includes a first end 170, a second end 171, a side 172, an inlet port 30, an outlet port 31, a pressure relief valve 33, a shut-off valve 32, locking slots 34 and 35, an inlet tube 149, an exit tube 150, a mating tube cavity 160, and a support shoulder cavity 161.

The inlet port 30 is the entrance point for liquid entering the filtration system 10 and the outlet port 31 is the exit point for liquid exiting the filtration system 10. The inlet port 30 and the outlet port 31 are located on the side 172 of the manifold 16. The inlet port 30 of the manifold 16 is connected to any outside liquid source such as a municipal water supply. The outlet port 31 is connected to an end use device such as a faucet, drink dispenser, or the like. The inlet port 30 is connected to an inlet tube 149. The inlet tube 149 transports liquid that passes through the inlet port 30 into the filter assembly 15. The outlet port 31 is connected to an exit tube 150. The liquid that has been filtered by the filter assembly 15 will travel into the exit tube 150 and through the outlet port 31 and ultimately to an end use device. The inlet port 30, the outlet port 31, the inlet tube 149, and the exit tube 150 are created using any suitable means such as during a molding process or machining.

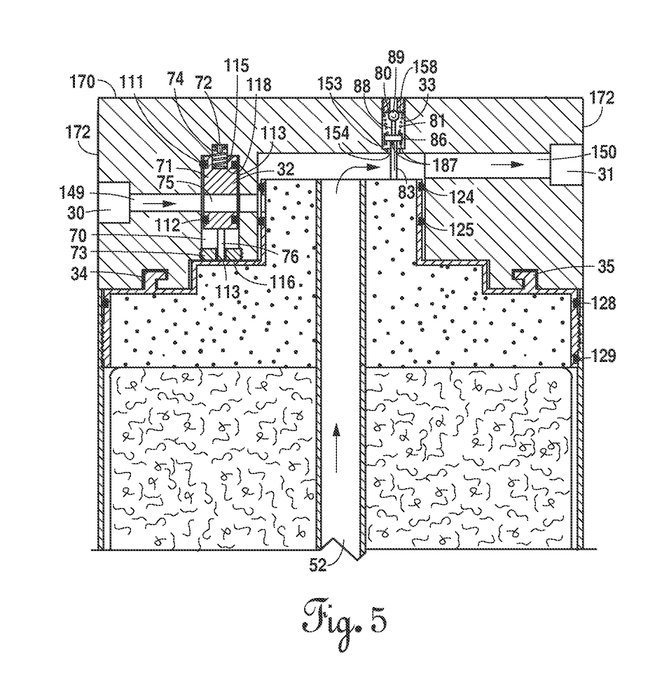

FIGS. 4 and 5 illustrate the pressure relief valve 33 of the manifold 16. The pressure relief valve 33 is designed to prevent leakage within the filtration system 10 when the filter assembly 15 is removed from the manifold 16. The pressure relief valve 33 is in a normally open position when the filter assembly 15 is detached from the manifold 16 and a closed position when the filter assembly 15 is connected to the manifold 16. The pressure relief valve 33 includes a pressure relief valve passage 153, a piston 80, a biasing member 81, which is a spring in the preferred embodiment, a cap 158, and a plunger inlet 154.

The pressure relief valve passage 153 receives the piston 80, the biasing member 81, and the cap 158. The pressure relief valve passage 153 is created using any suitable means such as during a molding process or machining. The piston 80 is designed to move up or down within the pressure relief valve passage 153 and either allow liquid under pressure to escape the filtration system 10 or to seal liquid under pressure within the filtration system 10 depending upon whether the pressure relief valve 33 is in the normally open or the closed position. The piston 80 may be made of any suitable material and means such as plastics molding. The piston 80 includes a platform 86, legs 187, a shaft 88, a ball valve 89, and a plunger 83. The platform 86 of the piston 80 includes a top 182, a bottom 183 and is the contact point for liquid under pressure that is trapped within the filtration system 10. The legs 187 connect to the bottom 183 of the platform 86 to prevent the platform 86 from sealing the plunger inlet 154. The shaft 88 connects the top 182 of the platform 86 with the ball valve 89. The ball valve 89 engages the cap 158 to seal liquid under pressure within the filtration system 10. The plunger 83 engages the filter assembly 15 to move the pressure relief valve 33 from a normally open to a closed state. The biasing member 81 engages the top 182 of the platform 86 and the cap 158 to bias the pressure relief valve 33 into a normally open position. The cap 158 seals the piston 80 and the biasing member 81 within the pressure relief valve passage 153 and includes an aperture 159 to allow liquid under pressure that enters the pressure relief valve passage 153 to escape the manifold 16. The plunger inlet 154 allows the plunger 83 to pass through the pressure relief valve passage 153 to engage the filter assembly 15 and allows liquid that resides within the exit tube 150 to pass into the pressure relief valve passage 153 and engage the platform 86 of the piston 80. The plunger inlet 154 is created using any suitable means such as during a molding process or machining.

The pressure relief valve 33 is assembled in the following manner. The piston 80 is placed within pressure relief valve passage 153, wherein the piston 80 is oriented so that the plunger 83 of the piston 80 is placed through the plunger inlet 154 and the ball valve 88 is facing the first end of the manifold 16. When placed within the pressure relief valve passage 153, the legs 187 of the piston 80 will engage the bottom of the pressure relief valve passage 153 to prevent the bottom 183 of the platform 86 from sealing the plunger inlet 154. The legs 187 provide a space between the bottom of the pressure relief valve passage 153 and the bottom 183 of the platform 86. This space allows liquid within the filtration system 10 to flow through the plunger inlet 154 and engage the platform 86 of the piston 80. After the piston 80 is placed within the pressure relief valve passage 153, the biasing member 81 is placed over the ball valve 89 and the shaft 88 and engages the top 182 of the platform 86. The cap 158 is placed within the pressure relief valve passage 153 and over the biasing member 81 thereby sealing the piston 80 and biasing member 81 within the pressure relief valve passage 153. The cap 158 is secured within the pressure relief valve passage 153 by any suitable means such as press fit, gluing, or threading. Operation of the pressure relief valve 33 will be explained in greater detail below.

FIGS. 4 and 5 illustrate the shut-off valve 32 of the manifold 16. The shut-off valve 32 is designed to prevent liquid from an outside source from entering the filter assembly 15 when the filter assembly 15 is removed from the manifold 16. The shut-off valve 32 is in a normally closed position when the filter assembly 15 is detached from the manifold 16 and an open position when the filter assembly 15 is coupled to the manifold 16. Movement of the shut-off valve 32 from its normally closed position to an open position allows liquid from an outside source to enter the filter assembly 15. The shut-off valve 32 includes a shut-off valve cavity 70, a piston 71, a biasing member 72, a cap 73, a recess 74, a first end 115, and a second end 116.

The shut-off valve cavity 70 receives the piston 71 and the cap 73. The shut-off valve cavity 70 is created using any suitable means such as during a molding process or machining. The piston 71 is designed to move up or down within the shut-off valve cavity 70 and either allow liquid to enter the filter assembly 15 or to prevent liquid from entering the filter assembly 15 depending upon whether the filter assembly 15 is coupled with the manifold 16. The piston 71 includes an aperture 75, a plunger 76, o-rings 111-112, o-ring grooves 201-202, and a recess 118. The piston 71 can be any suitable shape and material but in the present embodiment of the invention the piston 71 is a cylinder and molded plastic. The aperture 75 of the piston 71 is placed at the center of the piston 71 and lines up with the inlet tube 149 of the manifold 16 when the shut-off valve 32 is in the open position. When the aperture 75 of the piston 71 lines up with the inlet tube 149, liquid is allowed to pass into the filter assembly 15. When the shut-off valve 32 is in the normally closed position the aperture 75 of the piston 71 is offset from the inlet tube 149 thereby preventing liquid from passing into the filter assembly 15. The plunger 76 engages the filter assembly 15 to move the shut-off valve 32 from a normally closed to an open position. The o-ring grooves 201-202 receive the o-rings 111-112. The o-rings 111-112 provide a seal that prevents liquid from entering the shut-off valve cavity 70 when liquid is passing through the aperture 75 of the piston 71. The recess 118 is located at the top of the piston 71 and receives the biasing member 72. The recess 74 is placed above the first end 115 of the shut-off valve cavity 70 and receives the biasing member 72. The biasing member 72 has a second end that engages the recess 118 of the piston 71 and a first end that engages the recess 74 to bias the shut-off valve 32 into a normally closed position. The cap 73 seals the piston 71 and the biasing member 72 within the shut-off valve cavity 70 and includes an aperture 113 to allow the plunger 76 to pass through the cap 73 and engage the filter assembly 15.

The shut-off valve 32 is assembled in the following manner. The biasing member 72 is placed within the recess 74. The first end of the biasing member 72 is placed within the recess 74. The o-rings 111-112 are secured to the piston 71 by placing the o-rings 111-112 within o-ring grooves 201-202. The piston 71 is placed within the shut-off valve cavity 70 and oriented so that the recess 118 is facing the first end 115 of the shut-off valve cavity 70 and the plunger 76 is facing the second end 116 of the shut-off valve cavity 70. The second end of the biasing member 72 is secured to the piston 71 by placing the second end of the biasing member 72 within the recess 118 of the piston 71. The aperture 75 of the cap 73 is aligned with the plunger 76 and the cap 73 is secured within the shut-off valve cavity 70 to maintain the shut-off valve 32 within the shut-off valve cavity 70. The cap 73 is secured within the shut-off valve cavity by any suitable means such as press fit, gluing, or threading. The alignment of the aperture 75 with the plunger 76 allows the plunger 76 to move freely through the cap 73 and engage the filter assembly 15. The operation of the shut-off valve 32 will be explained in greater detail below.

The locking slots 34 and 35 are located on the second end 171 of the manifold 16 and are designed to secure the filter assembly 15 from the manifold 16. The locking slots 34 and 35 include a receiving slot 90 and 91, and a locking rail 100 and 101. The receiving slots 90 and 91 and the locking rails 100 and 101 lock the filter assembly 15 to the manifold 16 and prevent accidental removal of the filter assembly 15 from the manifold 16. The mating tube cavity 160 and the support shoulder cavity 161 receive the filter assembly 15.

FIGS. 1 and 2 illustrate the filter assembly 15. The filter assembly 15 includes a flow tube 21, an interlocking connector 17, a filter cartridge 19, and a filter housing 18. The flow tube 21 is a cylinder that runs from the top of the filter assembly 15 to a location that is substantially and completely at the bottom of the filter assembly 15. The flow tube 21 includes an intake opening 52 and an exit opening 53. The flow tube 21 allows liquid that has been filtered by the filter cartridge 19 to be transported into the manifold 16 and out of the filtration system 10.

The interlocking connector 17 is cylindrical in shape and designed to mate with the manifold 16. The interlocking connector 17, which is preferably constructed from a plastics material through a molding process, includes a base 40, a mating tube 41, a support shoulder 43, o-rings 124-125 and o-ring groves 132-133. The base 40 is located at the top of the filter housing 18 and includes locking tabs 22 and 23. The locking tabs 22 and 23 are placed within the locking slots 34 and 35 of the manifold 16 to facilitate the locking the filter assembly 15 to the manifold 16. The operation of the locking tabs 22 and 23 will be explained in greater detail below. The mating tube 41 connects with the mating tube cavity 160 of the manifold 16 and includes a top 45 and an intake port 42. The top 45 of the mating tube 41 is an engagement point between the filter assembly 15 and the plunger 83 of the pressure relief valve 33 and also includes the exit opening 53 of the flow tube 21. The intake port 42 of the mating tube 41 receives liquid from an outside source after it passes through the manifold 16. Liquid passed into the intake port 42 travels into the interlocking connector 17 and then into the filter cartridge 19 for filtering. The support shoulder 43 is located on top of the base 40 and provides support for the mating tube 41. The support shoulder 43 connects with the support shoulder cavity 161 of the manifold 16 and is also an engagement point between the filter assembly 15 and the shut-off valve 60.

The o-rings 124-125 provide a seal to prevent liquid from escaping the filter assembly 15 after entering the interlocking connector 17. The o-ring grooves 132-133 provide an attachment point for the o-rings 124-125. The o-rings 124 and 125 are placed at the top and bottom of the intake port 42 within the o-ring grooves 132 and 133 and the o-rings 126 and 127 are placed within the o-ring grooves 134 and 135.

The filter cartridge 19 is cylindrical in shape and is hollow in the center to allow for the passage of the flow tube 21. The filter cartridge 19 includes filter media designed to filter liquid that enters the filter cartridge 19. The filter media within the filter cartridge 19 may be of any suitable material or combination of materials such as sediment, carbon, or polyphosphate. After liquid enters the filter assembly 15, the pressure from the liquid source forces liquid through the interlocking connector 17 and into the filter cartridge 19 where it is filtered.

The filter housing 18 is cylindrical in shape and receives the filter cartridge 19 and the interlocking connector 17. The filter housing 18 includes a flow channel 50, o-rings 128-129, and o-ring grooves 136-137. The flow channel 50 receives liquid that enters the filter assembly 15 and is filtered by the filter cartridge 19. After liquid has been filtered by the filter cartridge 19 it is held within the flow channel 50 until it is transported by the flow tube 21 into the manifold 16. The o-rings 128-129 provide a seal to prevent liquid from escaping the filter assembly 15 after the liquid enters the interlocking connector 17 and the filter cartridge 19. The o-ring grooves 136-137 provide an attachment point for the o-rings 128-129. The o-rings 128-129 are placed within the o-ring grooves 136-137. The filter housing 18 can be made of any suitable material but in the preferred embodiment the filter housing 18 is made of plastic through a molding process.

The filter assembly 15 is assembled in the following manner. The o-rings 124-125 are placed within the o-ring grooves 132-133. The interlocking connector 17 is mated to the filter cartridge 19 by any suitable means such as glue. Both the interlocking connector 17 and the filter cartridge 19 are placed within the filter housing 18. The o-rings 128-129 are placed between the interlocking connector 17 and filter housing 18 within the o-ring grooves 136-137. After placement of the o-rings 128-129 between the interlocking connector 17 and the filter housing 18, the interlocking connector 17 and the filter housing 18 are attached by any suitable means such as sonic welding. Alternatively, threading may be provided within the filter housing 18 and the outside of the interlocking connector 17. The threading would be provided within an upper portion of the filter housing 18 and adjacent the interlocking connector 17, the interlocking 17 would also include threading on the outside that would be adjacent to the threading of the filter housing 18. Threading the filter housing 18 and the interlocking connector 17 would allow the removal of the interlocking connector 17 and the filter cartridge 19 from the filter housing 18. By allowing removal of the interlocking connector 17 and filter cartridge 19 from the filter housing 18, the filter housing 18 can be reused after sufficient cleaning thereby preventing waste.

The operation of the filtration system 10 includes attaching the filter assembly 15 to the manifold 16 and removing the filter assembly 15 from the manifold 16. The operation of attaching the filter assembly 15 to the manifold 16 is as follows. The locking tabs 22 and 23 are lined up with the receiving slots 90 and 91 of the locking slots 34 and 35. The mating tube 41 is placed within the mating tube cavity 160 and the support shoulder 43 is placed within the support shoulder cavity 161. With the locking tabs 22 and 23 lined up with the receiving slots 90 and 91 and the mating tube 41 and the support shoulder 43 placed within the mating tube cavity 160 and the support shoulder cavity 161, the locking tabs 22 and 23 are inserted into the receiving slots 90 and 91 and rotated along the locking rails 100 and 101 until they are locked into position. As the locking tabs 22 and 23 are inserted into the receiving slots 90 and 91, the plunger 76 of the shut-off valve 32 engages the support shoulder 43 of the interlocking connector 17 and the plunger 83 of the pressure relief valve 33 engages the top 45 of the mating tube 41. Engagement of the plunger 76 with support shoulder 43 of the interlocking connector 17 overcomes the biasing force of the biasing member 72 and moves the shut-off valve 32 from a normally closed position into an open position. With the shut-off valve 32 in the open position, the aperture 75 of the piston 71 aligns with the inlet tube 149 to allow liquid to pass into the filter assembly 15. Engagement of the plunger 83 with the top 45 of the mating tube 41 overcomes the biasing force of the biasing member 81 and moves the piston 80 of the pressure relief valve 33 from a normally open into a closed position. In the closed position the ball valve 89 of the piston 80 seals the aperture 159 of the cap 158 thereby preventing any liquid under pressure that is trapped within the filtration system 10 from escaping.

After the shut-off valve 32 is moved into an open position and the pressure relief valve 33 is moved into a closed position, liquid passes from the inlet port 30 of the manifold 16 and into the inlet tube 149. Liquid travels within the inlet tube 149 and passes through the aperture 75 of the piston 71. After passing through the aperture 75 of the piston 71 liquid will travel through the intake port 42 and into the interlocking connector 17. Fluid pressure forces liquid that enters the interlocking connector 17 to be transported to the filter cartridge 19 where the liquid is filtered and passes into the flow channel 50 of the filter housing body 18. After liquid passes into the flow channel 50 it is ready to be transported to an outside source. When an end user operates an outside source such as a water tap, pressure within the system forces the liquid from the flow channel 50 and into the intake tube 52 of the flow tube 21. The liquid contained within the flow tube 21 will be forced out of the exit opening 53 and into the exit tube 150. Liquid will then pass the plunger 83 of the pressure relief valve 33 and exit out of the manifold 16 through the outlet port 31 to the end source.

The operation of removing the filter assembly 15 from the manifold 16 is as follows. The operator will rotate the filter assembly 15 so that the locking slots 22 and 23 line up with the receiving slots 90 and 91 of the manifold 16. After the operator rotates the filter assembly 15 so that the locking slots 22 and 23 line up with the receiving slots 90 and 91 of the manifold 16 the operator can remove the filter assembly 15 from the manifold 16.

As the operator begins removing the filter assembly 15 from the manifold 16 the plunger 76 of the shut-off valve 32 and the plunger 83 of the pressure relief valve 33 begin to disengage from the support shoulder 43 of the interlocking connector 17 and the top 45 of the mating tube 41. After disengagement of the plunger 76 with the support shoulder 43 the biasing force of the biasing member 72 moves the piston 71 of the shut-off valve 32 into a closed position. In the closed position the aperture 74 of piston 71 resides offset from the inlet tube 149 to prevent liquid from passing into the filter assembly 15. After disengagement of the plunger 83 with the top 45 the biasing force of the biasing member 81 moves the piston 80 of the pressure relief valve 33 into an open position. With the pressure relief valve 33 in the open position, the ball valve 89 of the piston 80 unseals the aperture 159 of the cap 158 thereby bleeding the pressure from any liquid trapped within the filtration system 10. In particular, a small amount of liquid passes the platform 86 of the piston 80 and escapes through the aperture 159 of the cap 158 thereby relieving pressure and preventing leakage.

1. A filtration system, comprising:
a manifold, including:
a mating tube cavity,
an inlet tube communicating with an inlet port and the mating tube cavity,
a shut-off valve disposed in the inlet tube, wherein the shut-off valve is in a normally closed position and is movable to an open position,
a pressure relief valve communicating with the mating tube cavity, wherein the pressure relief valve is in a normally open position and is movable to a closed position, and
an exit tube communicating with the mating tube cavity and an outlet port; and
a filter assembly, comprising:
a filter cartridge,
a filter housing having the filter cartridge disposed therein,
an interlocking connector including a mating tube having an intake port, the interlocking connector being disposed atop and in fluid communication with the filter cartridge and coupled with the filter housing, wherein engagement of the interlocking connector with the manifold inserts the mating tube within the mating tube cavity and aligns the intake port of the interlocking connector with the inlet tube of the manifold, further wherein engagement of the interlocking connector with the manifold moves the shut-off valve from its normally closed position to its open position and the pressure relief valve from its normally open position to its closed position, thereby facilitating the delivery of liquid into the filter cartridge, and
a flow tube disposed within the filter cartridge and the interlocking connector, the flow tube communicating exterior to the interlocking connector, wherein the engagement of the interlocking connector with the manifold aligns the flow tube with the mating cavity such that filtered liquid from the filter cartridge flows from the flow tube into the mating cavity and to the exit port through the exit tube.

2. The filtration system according to claim 1, wherein the manifold includes a shut-off valve cavity intersecting the inlet tube of the manifold.

3. The filtration system according to claim 2, wherein the shut-off valve, comprises;
a piston having an aperture therethrough disposed in the shut-off valve cavity;
a cap disposed in the shut-off valve cavity for securing the piston within the shut-off valve cavity;
a plunger connected with the piston and extending from the shut-off valve cavity; and
a biasing member disposed in the shut-off valve cavity and coupled with the piston, wherein the biasing member biases the piston to block the inlet tube, further wherein the interlocking connector upon engagement with the manifold pushes the plunger, thereby moving the piston within the shut-off valve cavity such that its aperture aligns with the inlet tube of the manifold.

4. The filtration system according to claim 3, wherein the manifold includes a support shoulder cavity adjacent the mating tube cavity.

5. The filtration system according to claim 4, wherein the interlocking connector includes a support shoulder, wherein, upon engagement of the interlocking connector with the manifold, the support shoulder pushes the plunger of the shut-off valve, thereby moving the piston within the shut-off valve cavity such that its aperture aligns with the inlet tube of the manifold.

6. The filtration system according to claim 3, wherein the manifold includes a pressure relief valve passage communicating with the mating cavity and exterior to the manifold.

7. The filtration system according to claim 6, wherein the pressure relief valve, comprises;
a piston disposed in the pressure relief valve passage;
a cap disposed in the pressure relief valve passage, the cap including an aperture therethrough communicating exterior to the manifold;
a plunger connected with the piston and extending from the pressure relief valve passage into the mating cavity; and
a biasing member disposed in the pressure relief valve passage and coupled with the piston, wherein the biasing member biases the piston away from the aperture of the cap, further wherein the interlocking connector upon engagement with the manifold pushes the plunger, thereby moving the piston within the pressure relief valve passage such that the piston seals the aperture of the cap.

8. The filtration system according to claim 7, wherein, upon engagement of the interlocking connector with the manifold, the mating tube of the interlocking connector pushes the plunger of the pressure relief valve, thereby moving the piston within the pressure relief valve passage such that the piston seals the aperture of the cap.

9. The filtration system according to claim 7, wherein, upon the removal of the interlocking connector from the manifold, the biasing member biases the piston away from the aperture of the cap such that liquid escapes through the aperture of the cap, thereby relieving pressure and preventing leakage.

10. The filtration system according to claim 1, wherein the manifold includes at least one locking slot.

11. The filtration system according to claim 10, wherein the interlocking connector includes at least one locking tab, wherein engagement of the interlocking connector with the manifold inserts the at least one locking tab into the at least one locking slot, further wherein rotation of the interlocking connector relative to the manifold locks the at least one locking tab into the at least one locking slot.

12. The filtration system according to claim 11, wherein the interlocking connector includes a base having the at least one locking tab thereon.

13. The filtration system according to claim 1, wherein the interlocking connector permanently connects with the filter housing, thereby making the filter assembly disposable.

14. The filtration system according to claim 1, wherein the interlocking connector removably connects with the filter housing, thereby making the filter cartridge replaceable.

15. A method for a filtration system, comprising:
coupling a filter assembly with a manifold such that an intake port of the filter assembly aligns with an inlet tube of the manifold and a flow tube of the filter assembly communicates with an exit tube of the manifold;
pushing with the filter assembly a shut-off valve of the manifold from its normally closed position to its open position such that liquid flows into the filter assembly from the inlet tube of the manifold and filtered liquid flows into exit tube of the manifold from the flow tube of the filter assembly; and
pushing with the filter assembly a pressure relief valve of the manifold from its normally open position to its closed position.

16. The method for a filtration system according to claim 15, wherein coupling the filter assembly with the manifold, comprises:
inserting at least one locking tab of the filter assembly into at least one locking slot of the manifold; and
rotating the filter assembly relative to the manifold thereby locking the at least one locking tab into the at least one locking slot.

17. The method for a filtration system according to claim 15, further comprising:
decoupling the filter assembly from the manifold;
releasing contact of the shut-off valve with the filter assembly such that the shut-off valve returns from its open position to its normally closed position, thereby preventing liquid flow into the filter assembly from the inlet tube of the manifold; and
releasing contact of the pressure relief valve with the filter assembly such that the pressure relief valve returns from its closed position to its normally open position, thereby allowing an escape of liquid through the pressure relief valve that relieves pressure and prevents leakage.

18. The method for a filtration system according to claim 17, further comprising coupling a new filter assembly from the manifold.
